(19) United States
(12) Patent Application Publication
(10) Pub. No.: US 2018/0232973 A1
(43) Pub. Date: Aug. 16, 2018

(54) SECURITY MANAGEMENT SYSTEM AND METHOD THEREOF

(71) Applicant: Barry Chun Ket Chai, Bandar Kinrara (MY)

(72) Inventor: Hon Seng Teh, Bandar Kinrara (MY)

(73) Assignee: Barry Chun Ket Chai, Bandar Kinrara (MY)

(21) Appl. No.: 15/840,320

(22) Filed: Dec. 13, 2017

(30) Foreign Application Priority Data
Feb. 10, 2017 (MY) PI 2016700442

(51) Int. Cl. G07C 9/00; G08B 13/196

(52) U.S. Cl. CPC G07C 9/00015; G08B 3/10; G08B 13/19613

(57) ABSTRACT

A security management system of a restricted-access facility includes a security node operated by a security officer, an occupant node operated by an occupant of the facility; a visitor node operated by a visitor, a server having a processor and database, operative to process information including visit data being any one or combination of a visit invitation to the visitor node from the occupant node, a visit request to the occupant from the visitor node or from the visitor through the security node, and generate a visitor pass defined by a QR code, and an online platform operated by the server and accessible by the security node, occupant node and visitor node, capable of receiving information inputs and displaying the information.

### CROSS-REFERENCE TO RELATED APPLICATION

The instant application claims priority to Malaysia Patent Application Ser. No. PI 2017700442 filed Feb. 10, 2017, the entire specification of which is expressly incorporated herein by reference.

### FIELD OF THE INVENTION

The present invention relates generally to a security management system and its method. More particularly, the present invention relates to a system and method for controlling access of visitors into restricted-access facilities and triggering emergency alerts within the facilities.

### BACKGROUND OF THE INVENTION

Existing security management system poses a lot of limitations. Not only are the manual and partially automated systems prone to errors due to mis-keying information and inconsistency in data entry, these systems also require more effort, time and physical space to keep track of paper documents, duplicate documents, maintain security of information and rectify errors.

In addition to that, the alarm systems of current security management system have limited functions and require improvements in the aspects of remote triggering of alarms, detection of emergency locations, notification of emergencies to the security officers and other relevant authorities, cancellation of false alarms and locating of alarms activated due to emergency cases.

Further, sharing, verifying and validating information between multiple users is not possible or is inefficient for existing conventional systems to handle matters including granting access into a facility, conducting check-in and check-out procedures, providing alerts of emergency happenings remotely to relevant authorities. Effective and swift communication between major parties who are involved in the security of a facility such as the security officers, occupants of one or more units within the facility and visitors lacks in current security management system, and thus there is a need for such system.

### SUMMARY OF THE INVENTION

The present invention aims to provide a security management system and method involving the security officers, occupants and visitors of a restricted-access facility. Such system adopts a cloud-based server having an online platform that offers separate portals for the security officers, occupants and visitors that are accessible via electronic devices connected to the cloud-based server, thereby enhancing efficiency of communication between the users of the system for security matters including facilitating visit request and invitation, allowing access of visitors, conducting check-in and check-out process, monitoring the facility remotely, triggering alarms and sending notifications to alert security officers and other relevant authorities remotely, providing directions and visual map or floor plans to emergency location, capturing images or videos of an emergency happening remotely as evidence.

In one of the preferred embodiments of the present invention, the security management system is a cloud-based computing system that comprises at least a security node operated by a security officer; at least an occupant node operated by an occupant of the facility; at least a visitor node operated by a visitor; one or more servers having at least one processor and a database, operative to process information including visit data being any one or combination of a visit invitation to the visitor node from the occupant node, a visit request to the occupant from the visitor node or from the visitor through the security node, and generate a visitor pass defined by a QR code; and an online platform operated by the server and accessible by the security node, occupant node and visitor node, capable of receiving information inputs and displaying the information; wherein the QR code is downloaded to the visitor node to be scanned by the security node as validation of the security pass for allowing access of the visitor into the facility upon acceptance of the visit request by the occupant node or visit invitation by the visitor node.

The security management system further comprises an alarm system connected to the security node that is operated by a computer with a display for showing the information of an emergency case, and having an audible alarm or a visible alarm, or combination thereof. If the alarm system is not available, a speaker for emitting sounds as audible alarm can be connected to the security node.

Preferably, the security management system comprises any one or combination of security officer portal, occupant portal and visitor portal. An emergency alert option is displayed in the occupant portal for allowing the occupant to send an alert of an emergency case to the security node. In addition, an emergency alert cancellation option is also available in the occupant portal for allowing the occupant to cancel an alert of an emergency case that is sent to the security node. The occupant node is connectable to one or more surveillance camera installed in the facility that is capable of capturing images and/or videos of the facility and sending the images and/or videos to the security node.

Further, it is preferred that a user authentication module is available for the online platform to allow security officer, occupant and visitor to sign up for an account of the online portal and log in to the online portal to gain access into the security officer portal, occupant portal and visitor portal respectively. Preferably, the online platform is accessible through a mobile application, web browser or combination thereof. The security node is equipped with a QR code capturing device and a program with QR code capturing and reading functions.

Another preferred embodiments of the present invention relates to the security management method of the restricted-access facility that comprises the steps of generating a visitor pass defined by a QR code to be downloaded to the visitor node upon acceptance of a visit request by an occupant node, or acceptance of a visit invitation by a visitor node, and scanning the QR code by a security node to validate the visitor pass for allowing access of the visitor into the facility, wherein the method (i.e., the generating and scanning steps) is conducted by a security management system having one or more servers with at least one processor and a database, and an online platform operated by the server and accessible by the security node, occupant node and visitor node.

Further steps involved in this preferred embodiment of the security management method for controlling visitor access includes validating visitor information provided by the visitor node or by the visitor through the security node; verifying compliance of the visit data with facility rules; sending notification about outcome of the visit request or visit invitation to the visitor; sending notification regarding the visit data of the accepted visit request or visit invitation to the security node; and checking out of the facility by the visitor through scanning the QR code using the security node.

Preferably, the security management method also involves steps of handling emergency cases, including sending alerts of an emergency case to the security node through an emergency alert option displayed in an occupant portal of the online portal accessible by the occupant node; sending images or videos captured by one or more surveillance camera installed in the facility to the security node by the occupant node; triggering an alarm through an alarm system or a speaker connected to the security node upon receiving alerts of an emergency case; sending notification of an emergency case to the security node, one or more emergency contact person or combination thereof; cancelling alerts of the emergency case through an emergency alert cancellation option displayed in the occupant portal by the occupant node and/or security portal by the security officer; sending notification of an emergency alert cancellation to the security node, one or more emergency contact person or combination thereof; and sending reminder notification of an unattended emergency alert within a certain time period to the security node, one or more emergency contact person, or combination thereof.

### BRIEF DESCRIPTION OF THE DRAWINGS

FIG. 1 is a flow chart showing an overall process for the security management method in allowing access of visitors into the restricted-access facility.

FIG. 2 is a flow chart showing the process of setting up accounts of security officers and occupants of the facility, and other information related to the facility.

FIG. 3 is a flow chart showing the process of sending a visit request by a visitor node.

FIG. 4 is a flow chart showing the process of sending a visit request by walk-in visitors through the security node.

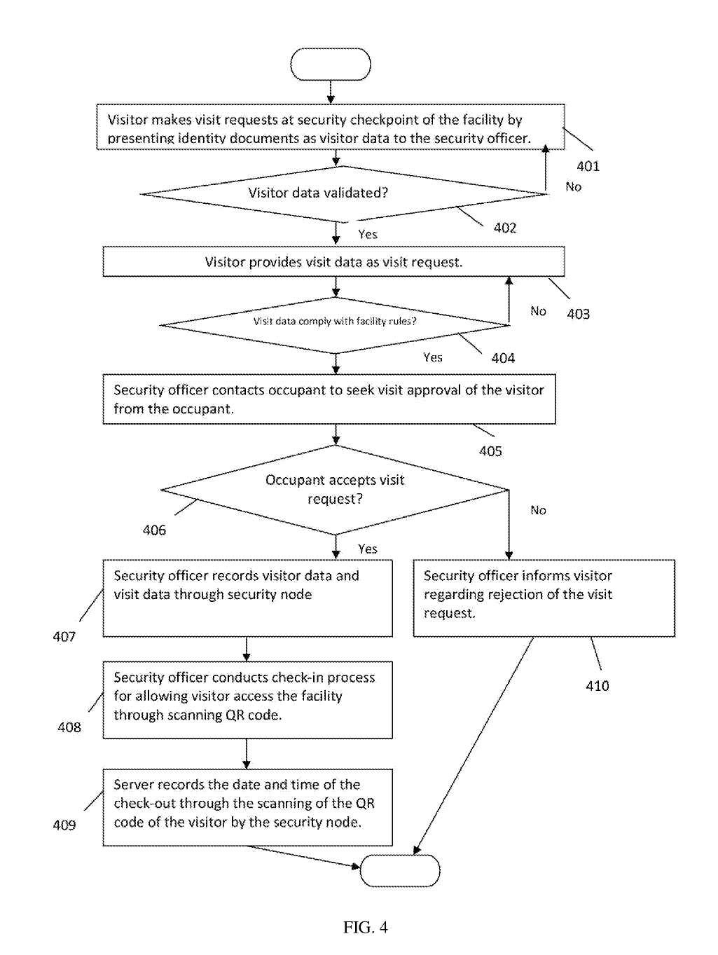

FIG. 5 is a flow chart showing the process of sending visit invitation by an occupant node.

FIG. 6 is a flow chart showing the process of checking in and out of the facility through scanning QR code with the security node.

FIG. 7 is a flow chart showing the process of sending alerts and notification of an emergency case by the occupant node.

FIG. 8 is a flow chart showing the process of cancelling alerts of an emergency case by the occupant node.

FIG. 9 is a flow chart showing the process of cancelling alerts of an emergency case by the security node.

FIG. 10 is a flow chart showing the process of sending reminder notifications of an unattended emergency alert within a certain time period to the security node, one or more emergency contact person, or combination thereof.

### DETAILED DESCRIPTION OF THE INVENTION

The present invention discloses a security management system and method of a restricted-access facility. It should be noted that the term “facility” used throughout this specification includes any places, premises, buildings, stations, centres, sites, gated communities and the like with controlled entrances. The term “security officer” indicates any authorities, including individuals and organizations appointed to control security of the facility, whereas “occupant” indicates residents, owners, or tenants, occupying one or more units, or the entire facility. On the other hand, “visitors” are defined as any guests who visit and enter the facility. The term “node” applied herein indicates portable or non-portable electronic devices that are connectable to the security management system through a telecommunications network, and capable of creating, receiving, or transmitting information over a communications channel, such as computers, phones, tablets, PDAs, smart watches, etc.

With the purpose to improve communication between security officers, occupants and visitors including the sharing of data and efficient transmission of a large variety of information, the security management system comprises at least a security code operated by a security officer of the facility, at least an occupant node operated by an occupant of the facility, at least a visitor node operated by a visitor of the facility, one or more servers having at least one processor and a database, operative to process information related to the security of the facility, and an online platform operated by the server and accessible by the security node, occupant node and visitor node, that is capable of receiving information inputs and displaying the information. Preferably, the system adopts cloud-computing to manage, process and store data.

Information that can be processed by the server, stored in the database and share and communicated between users of the system including the administrator of the system, security officers, occupants and visitors can be in any media format such as text, audio, video and image. The information comprises any one or combination of facility data; security data, occupant data; visitor data, list of blacklisted visitors, visitor pass including QR code, visit data, and details of an emergency case. “Facility data” includes any data relevant to the facility including visual map of the facility, floor plans of the facility, facility rules, etc., whereas “visit data” includes information on any visit requests and visit invitations. “Details of an emergency case” includes location of the emergency case, occupant of the emergency location, person who trigger alarm of the emergency case, receiver of the emergency notification, starting time, ending time and duration of the alert, images or videos captured during the emergency case as evidence, cancellation of the alarm, etc.

To ease management of information and improve usability of the system for the users, the online platform comprises any one or combination of security officer portal, occupant portal and visitor portal. A user authentication module is provided in the system for the online platform to allow security officer, occupant and visitor to sign up for an account of the online portal and log in to the online portal to gain access into the security officer portal, occupant portal and visitor portal respectively, thereby enhancing security and privacy protection of the information. The online platform is accessible through a mobile application, web browser or combination thereof.

Alarm system in a facility is important in providing alerts of an emergency case to relevant authorities for immediate action to be taken to solve the emergency case. The emergency case indicates any dangerous situations that require immediate action. To make sure relevant authorities receive the alerts and notifications with clear directions and sufficient information for taking the immediate action, the present invention is equipped with an alarm system connected to the security node that is operated by a computer with a display for showing the information of an emergency case such as address, map, floor plan, occupant data of the unit in which the emergency case happened. The alarm system further comprises an audible alarm such as a siren or a visible alarm such as a strobe light, or combination thereof to emit sounds or visible signals at a place close to the security node, such as the security checkpoint, security room, guard house or locations stationed with security officers for alerting the security officers. However, if an alarm system is not available, a speaker is applicable through connecting to the security node to emit sounds as audible alarm for the emergency case.

Installation of surveillance camera such as CCTV and IP camera within facilities is common for monitoring environment and activities around the location of the camera. The present invention incorporates features of capturing images and/or videos of the facility through the surveillance camera using the occupant node via the occupant portal when the occupant detects an emergency case within the occupant's unit, and sending the captured images and/or videos as evidence to the security node. Such features are achievable through connecting the occupant node with the surveillance cameras. It is also possible for the surveillance camera of common areas within the facility to be connected to the security node for capturing images and/or videos of emergency cases as evidence and sharing the evidence to other relevant authorities through the security portal using the security node. Capturing and sending of the images and/or videos to the security node can be done manually or automatically. The automatic capturing and sending of the images and/or videos as evidences is performed after the emergency alert option is activated.

Further, the system comprises an emergency alert option in the occupant portal for allowing the occupant to send an alert of an emergency case to the security node. Preferably, the emergency alert option is in button form, but it can also in other widget form that allows an action, which can be a click, tap or swipe to be performed on the emergency alert option for sending the alert to the security node, thereby activating the alarm system to emit the audible and/or visible alerts. Details of the emergency case are also delivered to the security node to be displayed on the screen of the security node or the display of the alarm system or combination thereof. If there is no alarm system connected to the security node, speakers that are connected to the security node emits audible alerts when the action is performed on the emergency alert option.

To cancel the emergency alert, the system is also provided with an emergency alert cancellation option in the occupant portal for allowing the occupant to cancel an alert of an emergency case that is sent to the security node. The emergency alert cancellation option can be in any widget form, for instance a button or link that allows an action including click, tap or swipe to be performed thereon for cancelling the alert through deactivating the alarms from emitting sound and/or light.

Visitor pass granted upon acceptance of a visit request or visit invitation is sent to the visitor node in the form of a QR code for the visitor to gain access into the facility by validating the visitor pass through scanning the QR code with the security node. Thus, the security node is equipped with a QR code capturing device and a program with QR code capturing and reading functions. Information regarding the visit including the visit data and visitor data are encrypted in the QR code such that upon successful scanning of the QR code, these information are received by the security node. Besides using the QR code to check in the facility, it can also be used to check out from the facility. When the visitor leaves the facility, the QR code is scanned by the security node to record the leaving time of the visitor.

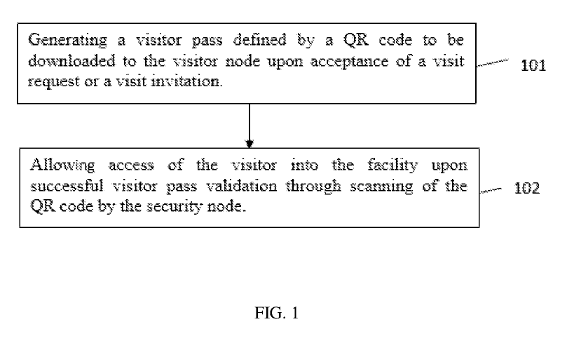

With reference to FIG. 1, the security management method carried out by the abovementioned security management system comprises the steps of generating a visitor pass defined by a QR code to be downloaded to the visitor node upon acceptance of a visit request by an occupant node, or acceptance of a visit invitation by a visitor node (101), and scanning the QR code displayed on the visitor node by a security node to allow access of the visitor into the facility upon successful visitor pass validation through scanning of the QR code by the security node (102).

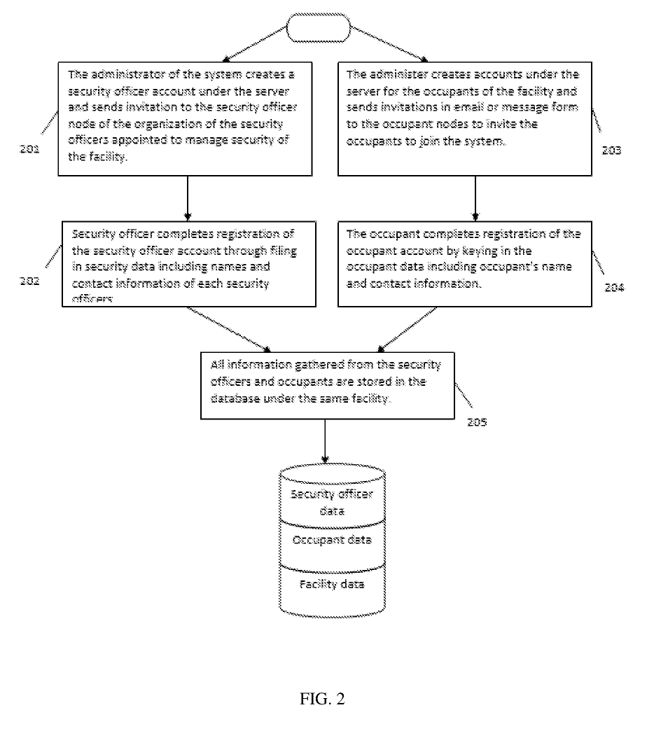

FIG. 2 shows detailed steps of the process to set up accounts of security officers and occupants of the facility, and other information related to the facility. The administrator of the system creates a security officer account under the server and sends invitation to the security node of the organization of the security officers appointed to manage security of the facility (201). Facility data such as facility rules including regulations for visits, visual map and floor maps of common areas of the facility are created and stored in the database of the system. Security officer completes registration of the security officer account through filing in security data including names and contact information of each security officers (202). At the same time, the administrator creates accounts under the server for the occupants of the facility. Facility data including the visual map and floor map of the facility of each unit of the occupant are uploaded to the occupants account respectively. The administrator sends invitations in email or message form to the occupant nodes to invite the occupants to join the system (203). The occupant completes registration of the occupant account by keying in the occupant data including occupant's name and contact information (204). All information gathered from the security officers and occupants are stored in the database under the same facility (205).

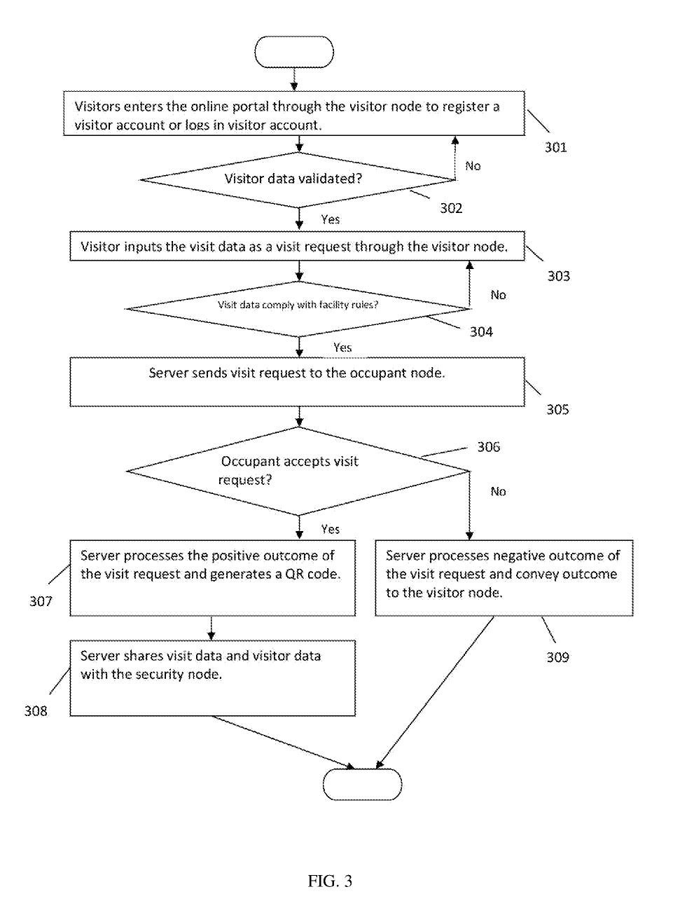

FIG. 3 is a flow chart showing the process of sending a visit request by a visitor node. First time visitors who have yet to visit the facility and register a visitor account on the online portal enters the online portal through the visitor node and register a visitor account (301) by filing up the visitor data including visitor's name and contact information. Visitor data is validated by the server (302). After that, the visitor inputs the visit data as a visit request (303) through the visitor node to the occupant including the data, time and purpose of the visit. For visitors who have already registered a visitor account, the visitor logs in (301) his visitor account through the visitor portal to make a visit request. The server verifies compliance of the visit data with facility rules (304). Upon successful verification, the server then sends the visit request to the occupant node (305). The occupant receives the visit request (306) through a message viewable from the online portal or email and provides an answer to the visit request. When the visit request is accepted by the occupant, the server processes the positive outcome of the visit request and generates a QR code (307) based at least on information of the visit data and visitor data. Upon generating the QR code, the QR code is sent to the visitor node for the visitor to download the QR code. After that, the server shares the visit data and visitor data with the security node (308). The data are viewable through the security officer portal to notify the security officer about an upcoming visitor. However, if the occupant rejects the visit request through the occupant node, the negative outcome of the visit request is conveyed to the visitor node through the server through message or email (309).

For walk-in visitors, visit requests can be made at the security checkpoint of the facility using the security node. The visitor presents his identity documents to the security officer (401) and informs the security officer the unit and name of the occupant the visitor wishes to visit for the security officer to record the visitor data and visit data into the server for validating the visitor identity through the security node (402). Next, the visitor provides information of the visit data including the date, time and purpose of visit for making a visit request (403). The server verifies compliance of the visit data with facility rules (404). When verification is successful, the security officer calls up or sends a message to the occupant node through the online portal to seek visit approval of the visitor from the occupant (405). The server checks if the visit request is accepted by the occupant (406). Upon acceptance of the visit request, the occupant sends the outcome of the visit request to the server. The security officer then records visitor data and visit data through security node (407) and conducts the check-in process for allowing the visitor access the facility through the QR code sent to the security node as a visitor pass for the visitor (408). When the visitor checks out of the facility through the security checkpoint of the facility using the security node, the server records the date and time of the check-out through the scanning of the QR code of the visitor (409). On the other hand, if the visit request is not accepted by the occupant, the occupant sends the outcome to the server through the occupant node to reject the visit request (410).

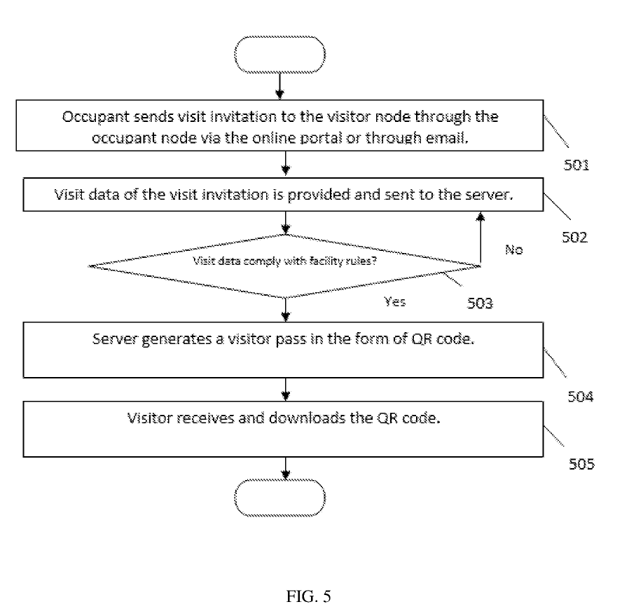

Referring to FIG. 5, the process of sending visit invitation to the visitor node through the occupant node is conducted via the online portal or through email (501). Visit data of the visit invitation including the date, time and purpose of visit can be determined by the occupant or visitor and sent to the server (502). Visitor can input his identity information as visitor data. The visitor data and visit data are validated to check if the data complies with the facility rules (503). The server then generates a visitor pass in the form of QR code and sends the QR code to the visitor node through the online portal or email (504). The visitor downloads the QR code for gaining access into the facility (504).

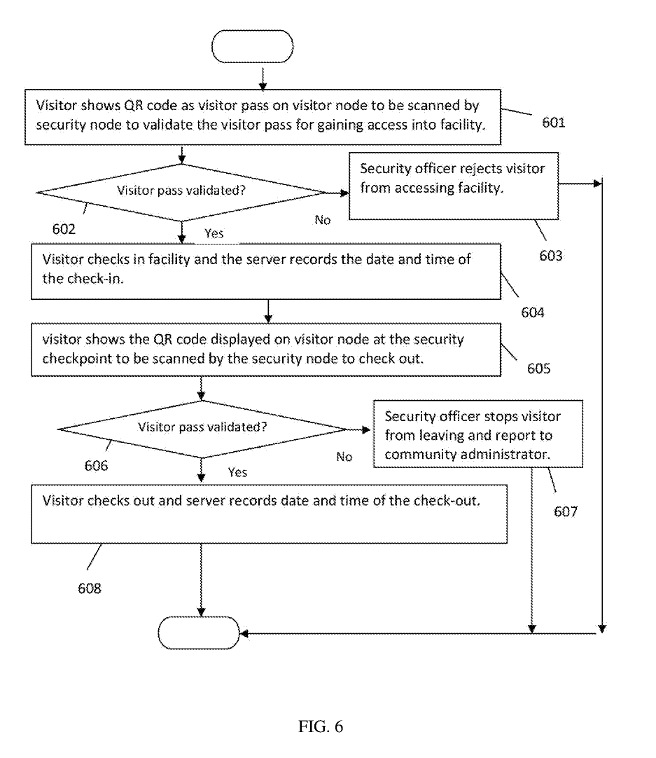

FIG. 6 is a flow chart showing the process of checking in and out of the facility through scanning QR code with the security node. The QR code downloaded into the visitor node is employed as a visitor pass to check-in and out of the facility. At the security checkpoint, the visitor shows the QR code on the visitor node to be scanned by the security node to validate the visitor pass (601). When validation (602) of the visitor pass is successful, the security officer grants access to the visitor, thereby allowing check-in of the visitor. The server records the date and time of the check-in (604). When validation (602) of the visitor pass fails, the security officer rejects visitor from entering the facility (603). During check-out, the visitor shows the QR code displayed on his visitor node at the security checkpoint to be scanned by the security node to validate the visitor pass (605). The visitor checks out and leaves the facility as soon as validation of the visitor pass is successful. The date and time of the check-out is recorded in the server (606). Otherwise, the security officer stops visitor from leaving the facility and reports to the community administrator (607).

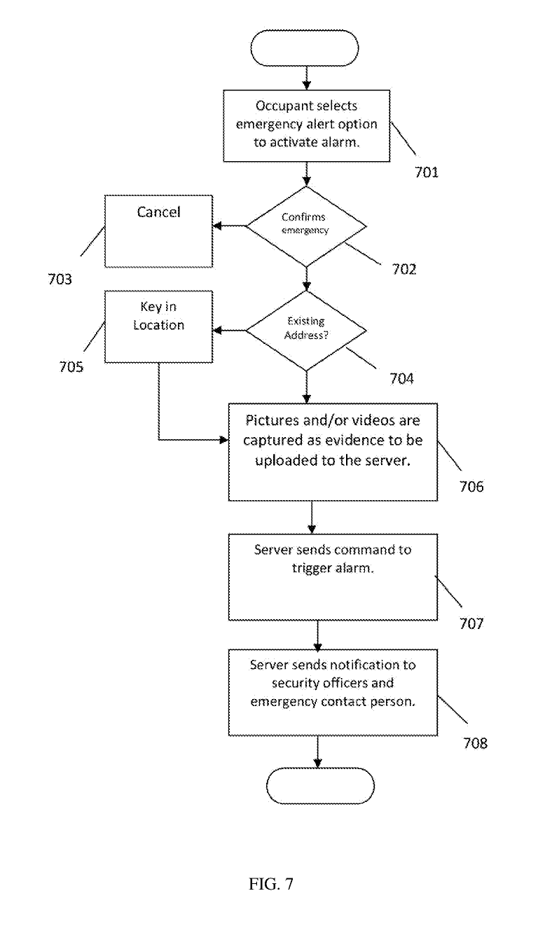

The process of sending alerts and notification of an emergency case by the occupant node is depicted in FIG. 7. Upon detection of the emergency case by the occupant, either locally or remotely from the occupant's unit, the occupant performs the action on the emergency alert option on the occupant's portal using the occupant node (701). The occupant confirms (702) or cancels (703) the emergency case for the next time. When emergency case is confirmed, the server asks the occupant through the occupant's portal if the location of the emergency case is the address registered in the system (704). Otherwise, the occupant informs the server the location of the emergency case (705). The server receives information of the emergency case location and captures pictures and/or videos of the location as evidence to be uploaded to the server (706). After that, the server triggers the alarm system to emit alerts, or activates the alarm configured in the security node for emitting alerts through the speaker connected to the security node (707). Notification of the emergency case is sent to the security nodes of one or more security officers, as well as the emergency contact person through message or email (708).

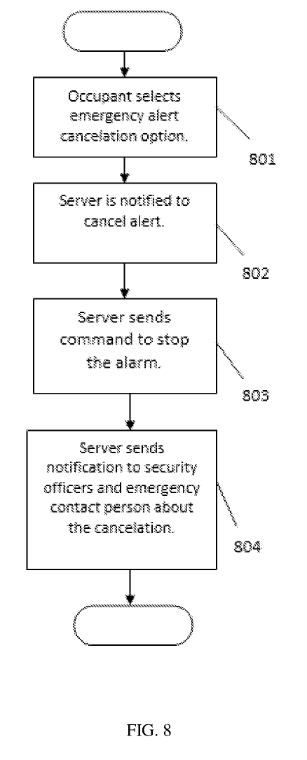

For cancelling alerts of an emergency case by the occupant node as illustrated in FIG. 8, the occupant performs the action on the emergency alert cancellation option on the occupant's portal (801) for notifying the server about the cancellation (802). The server then sends command to stop the alarm system or the security node that emits audible alarms through the speaker (802). Following the stopping of the alarm, the server sends notification through message or email to the security officers and emergency contact person who received the emergency alert notification (803).

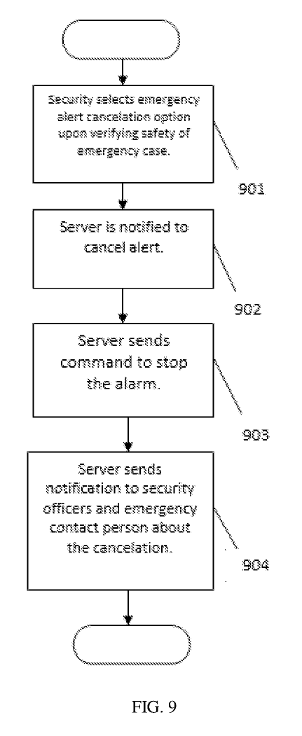

FIG. 9 is a flow chart showing the process of cancelling alerts of an emergency case by the security node. Upon verification of safety of the emergency case, the security officer performs the action on the emergency alert cancellation option on the security portal of the online platform (901) using the security node to stop the alarm. The server is then notified to cancel the alarm (902) and a command is sent by the server to deactivate the alarm (903). Notification about the cancellation of the emergency alert in various forms including message, email, etc. can be sent to the nodes of relevant authorities such as security nodes of other security officers and nodes of emergency contact person (904).

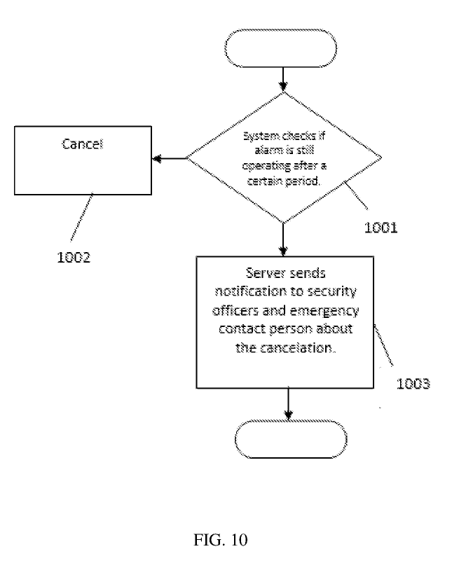

FIG. 10 illustrates a flow chart showing the process of sending reminder notifications of an unattended emergency alert within a certain time period to the security node, one or more emergency contact person, or combination thereof. For example, the system checks if the alarm is still operating after 15 minutes (1001). The checking can be cancelled if no reminder is required (1002). If no action is still taken by relevant authorities of the emergency case, the server sends notification in message or email form to security nodes of security officers and nodes of emergency contact person (1003).

Although the description above contains many specifications, it is understood that the embodiments of the preferred form are not to be regarded as a departure from the invention and it may be modified within the scope of the appended claims.

What is claimed is:

1. A security management system of a restricted-access facility, comprising:
a security node operated by a security officer;
an occupant node operated by an occupant of the facility;
a visitor node operated by a visitor;
one or more servers having a processor and a database, operative to process information including visit data being any one or combination of a visit invitation to the visitor node from the occupant node, a visit request to the occupant from the visitor node or from the visitor through the security node, and generate a visitor pass defined by a QR code; and
an online platform operated by the server and accessible by the security node, occupant node and visitor node, capable of receiving information inputs and displaying the information;
wherein the QR code is downloaded to the visitor node to be scanned by the security node as validation of the security pass for allowing access of the visitor into the facility upon acceptance of the visit request by the occupant node or visit invitation by the visitor node.

2. The security management system according to claim 1, further comprising an alarm system connected to the security node that is operated by a computer with a display for showing the information of an emergency case, and having an audible alarm or a visible alarm, or combination thereof.

3. The security management system according to claim 1, further comprising a speaker connected to the security node for emitting sounds as audible alarm for an emergency case.

4. The security management system according to claim 1, wherein the online platform comprises any one or combination of security officer portal, occupant portal and visitor portal.

5. The security management system according to claim 4, further comprising an emergency alert option in the occupant portal for allowing the occupant to send an alert of an emergency case to the security node.

6. The security management system according to claim 4, further comprising an emergency alert cancellation option in the occupant portal for allowing the occupant to cancel an alert of an emergency case that is sent to the security node.

7. The security management system according to claim 4, further comprising a user authentication module for the online platform to allow security officer, occupant and visitor to sign up for an account of the online portal and log in to the online portal to gain access into the security officer portal, occupant portal and visitor portal respectively.

8. The security management system according to claim 1, wherein the online platform is accessible through a mobile application, web browser or combination thereof.

9. The security management system according to claim 1, wherein the security node is equipped with a QR code capturing device and a program with QR code capturing and reading functions.

10. The security management system according to claim 1, wherein the occupant node is connectable to one or more surveillance cameras installed in the facility that is capable of capturing images or videos of the facility and sending the images or videos to the security node.

11. The security management system according to claim 1, wherein the information comprises any one or combination of facility data including visual map of the facility, floor plans of the facility, facility rules, security data, occupant data, visitor data, list of blacklisted visitors, visitor pass including QR code, visit data, and details of an emergency case.

12. The security management system according to claim 1, wherein the server is a cloud computing system.

13. A security management method of a restricted-access facility, comprising the steps of:
generating a visitor pass defined by a QR code to be downloaded to a visitor node upon acceptance of a visit request by an occupant node, or acceptance of a visit invitation by the visitor node; and
scanning the QR code by a security node to validate the visitor pass for allowing access of the visitor into the facility;
wherein the generating and scanning steps are performed by a security management system having one or more servers with a processor and a database, and an online platform operated by the server and accessible by the security node, occupant node and visitor node.

14. The security management method according to claim 13, further comprising the step of validating visitor information provided by the visitor node or by the visitor through the security node.

15. The security management method according to claim 13, further comprising the step of verifying compliance of visit data with facility rules.

16. The security management method according to claim 13, further comprising the step of sending a notification about outcome of the visit request or visit invitation to the visitor.

17. The security management method according to claim 13, further comprising the step of sending a notification regarding the visit data of the accepted visit request or visit invitation to the security node.

18. The security management method according to claim 13, further comprising the step of checking out of the facility by the visitor through scanning the QR code using the security node.

19. The security management method according to claim 13, further comprising the step of sending alerts of an emergency case to the security node through an emergency alert option displayed in an occupant portal of the online portal accessible by the occupant node.

20. The security management method according to claim 13, further comprising the step of sending images or videos captured by one or more surveillance camera installed in the facility to the security node by the occupant node.

21. The security management method according to claim 13, further comprising the step of triggering an alarm through an alarm system or a speaker connected to the security node upon receiving alerts of an emergency case.

22. The security management method according to claim 13, further comprising the step of sending a notification of an emergency case to the security node, one or more emergency contact person or combination thereof.

23. The security management method according to claim 19, further comprising the step of cancelling alerts of the emergency case through an emergency alert cancellation option displayed in the occupant portal by the occupant node, or security node by the security officer.

24. The security management method according to claim 19, further comprising the step of sending a notification of an emergency alert cancellation to the security node, one or more emergency contact person, or combination thereof.

25. The security management method according to claim 19, further comprising the step of sending a reminder notification of an unattended emergency alert within a certain time period to the security node, one or more emergency contact person, or combination thereof.
